(19) United States
(12) Patent Application Publication
(10) Pub. No.: US 2001/0004872 A1
(43) Pub. Date: Jun. 28, 2001

(54) Moldable composite building material and method of doing same

(76) Inventors: Robert Sullivan, Snyder, OK (US); Gary Sullivan, Mountain View, OK (US); Anthony Harwell, Amarillo, TX (US)

Correspondence Address: Dunlap, Codding & Rogers, P.C., Suite 420, 9400 North Broadway, Oklahoma City, OK, 73114, US

(21) Appl. No.: 09/757,420

(22) Filed: Jan. 10, 2001

Related U.S. Application Data
(63) Continuation of application No. 09/120,813, filed on Jul. 22, 1998, now abandoned.
Application No. 09/120,813 is a continuation-in-part of application No. 08/745,552, filed on Nov. 12, 1996, now abandoned.
Application No. 08/745,552 is a continuation-in-part of application No. 08/369,052, filed on Jan. 5, 1995, now abandoned.

(51) Int. Cl. C04B 12/04; C04B 24/10; C04B 28/26

(52) U.S. Cl. 106/618

(57) ABSTRACT

A moldable composite building material which can be formed into structural elements, such as blocks or bricks, is provided. The moldable composite building material is composed primarily of gin trash combined with a binder and a sealer. The gin trash is mixed with the binder and either molded or extruded into the desired shape, creating a compacted material. The compacted material is then cut, if necessary, and coated with a sealer to form the moldable composite building material.

### CROSS-REFERENCE TO RELATED APPLICATIONS

This application is a continuation-in-part of U.S. Ser. No. 08/745,552, filed Nov. 12, 1996, entitled “MOLDABLE COMPOSITE BUILDING MATERIAL AND METHOD FOR PRODUCING SAME”, which is a continuation-in-part of U.S. Ser. No. 08/369,052, filed Jan. 5, 1995, entitled “MOLDABLE COMPOSITE BUILDING MATERIAL AND METHOD FOR PRODUCING SAME.”

### STATEMENT REGARDING FEDERALLY SPONSORED RESEARCH OR DEVELOPMENT

Not applicable.

### BACKGROUND OF THE INVENTION

1. Field of the Invention

The present invention relates to moldable composite building materials, and more particularly, but not by way of limitation, to moldable composite building materials containing waste agricultural cellulose materials, as well as methods for producing such moldable composite building materials.

2. Brief Description of the Related Art

The processing of cotton in the Southern High Plains of Texas results in huge quantities of agricultural waste which is costly for the gins to dispose of. The present invention provides an efficient and cost effective way to handle the disposal of the agricultural waste by-product known as gin trash.

Virtually all cotton produced today is harvested by machine and it is contemplated that the gin trash used in carrying out the claimed invention would be produced primarily by a cotton stripper. Cotton strippers go over the field only once after the plants are desiccated either by frost or the application of chemicals. In the harvesting process strippers collect a large quantity of leaves, burs, stalks, other plant materials and soil particles. The material which is collected by the strippers is transported to the gin where the lint, seeds, and foreign matter is separated from the cotton. This foreign matter, which constitutes from about 500 to 700 lbs. per bale of cotton, is known in the art as “gin trash”. The gin trash accumulates at the gin and must be disposed off site. Indeed, the gin is often forced to pay as much as $5.00 per ton to have it processed off site.

The gin trash also contains soil particles known in the art as “fine trash” or “fines”. The fines may constitute from about 10% to 30% of the gin trash by weight.

| | | |
|---|---|---|
| Gin trash physical properties | 96 | (dry basis) |
| 4 Lint | 7.7 | |
| Burs | 56.6 | |
| Sticks | 10.7 | |
| Fines | 24.9 | (soil particles) |

Traditionally, the gin trash is disposed of by hauling it back to the fields where it is spread out at a cost, fed to cattle in hard years, and/or made into compost. The present invention eliminates the need to haul and/or process the gin trash at an economic loss. Instead, the present invention contemplates forming the gin trash into composite moldable building blocks, thereby producing a revenue generating and waste reducing product.

The prior art describes various uses for agricultural wastes and/or gin trash which are currently being used; however these uses and/or processes require substantial pretreatment of the agricultural waste and/or gin trash by washing, soaking, drying and/or cutting before use.

### BRIEF DESCRIPTION OF THE SEVERAL VIEWS OF THE DRAWING

FIG. 1 is a diagrammatic view of an apparatus for manufacturing moldable composite building materials in accordance with the present invention.

FIG. 2 is a perspective view of an extrusion tube of the apparatus of FIG. 1 employed in the manufacture of the moldable composite building materials of the present invention.

FIG. 3 is a perspective view of a building block formed of waste agricultural cellulose materials in accordance with the present invention.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The term “waste agricultural by-product materials” as used herein is understood to be agricultural processing trash obtained by the ginning of cotton and includes seed, raw cellulose materials, bolls, stems, leaves, foreign material, combinations thereof and the like.

The term “cotton gin waste products” as used herein is understood to be the cotton gin trash obtained by the ginning of cotton and includes cotton seed, raw cotton, cotton bolls, stems, leaves and foreign material which results from the cleaning of cotton. The term “cotton gin trash” is well known in the art and the process of producing cotton gin trash in cotton gins is also well known in the art as described and defined in Economic Implications of Pelleting Cotton Gin Trash as an Alternative Energy Source, by Donald S. Moore, Ronald D. Lacewell, and Calvin Parnell, p. 4 (1982).

The term “fine” as used herein is understood to be materials other than the agricultural cellulose material that may be present in the agricultural waste resulting from the stripping of cotton and the cleaning of the cotton lint. The term “fines” is well known in the art as discussed in Economic Implications of Pelleting Cotton Gin Trash as an Alternative Energy Source, by Donald S. Moore, Ronald D. Lacewell, and Calvin Parnell, P.4 (1982).

The moldable composite building materials of the present invention substantially comprises untreated gin trash mixed with a binder to form a moldable building material such as a block or a brick. The amount of gin trash employed in the fabrication of the individual building blocks or bricks can vary widely and will depend upon the properties desired in the moldable composite building materials. Generally, however, the amount of gin trash employed in the fabrication of the moldable composite building material will be from about 85% to 90% of the total weight of the building blocks or bricks.

The effective minor amount of binder employed in the fabrication of the moldable composite building material is binder in an amount effective to bind the untreated waste agricultural by-product gin trash into a solid compressed building block. The amount may vary from about 3% to 10% of the weight of the blocks or bricks.

Similarly, the effective amount of sealer used to fabricate the moldable composite building material is an amount to effectively render the composite material fluid impervious. The amount of sealer may vary from about 3% to 7% by weight of sealer.

Similarly, the moldable blocks may be treated with minor amounts of fire retardant agents capable of effectively rendering the blocks to be retardant of fires.

The untreated gin trash employed in the moldable composite building materials of the present invention is contemplated as being desiccated gin trash without any further processing treatment.

Any suitable binder capable of providing the desired adhesion between the material found in the gin trash can be employed in the fabrication of the moldable composite building materials. Examples of binder materials which can be employed in the fabrication of the moldable composite building materials of the present invention include sodium silicates, such as OXYCHEM® Grade 40 Clear Sodium Silicate distributed by Mid-America Chemical, Inc., of Oklahoma City, Okla. and urea-formaldehyde glues. The particular binder selected will be dependent upon the properties desired in the moldable composite building material. For example, when employing sodium silicate as a binder, fire resistant properties are imparted to the moldable composite building material because of the fire resistant properties of sodium silicate.

The sealer employed in the fabrication of the moldable composite building materials of the present invention functions as a coating to prevent water and moisture from entering the moldable composite building material and to further prevent passage of air or gasses therethrough so as to impart the desired structural and insulation properties to the moldable composite building materials. In addition, the sealer can be employed to impart a desired color or texture to the moldable composite building materials.

Any sealer capable of stopping fluid passage through the moldable composite building material can be employed. Such sealers, conventionally known as wood and fiber sealers, are well known in the art. An example of a suitable sealer is latex paint, such as Sherwin-Williams® Outdoor Latex Paint which can be purchased at any local paint or hardware store.

As previously stated, it may be desirable, especially when utilizing urea-formaldehyde glues as the binder, to incorporate a fire retardant agent into the moldable composite building material. The amount of fire retardant agent employed can vary widely, but will generally be present in an amount of from about 1 to about 5 weight percent. Examples of fire retardant agents which can be used with the present invention are triphenyl phosphate, decabromide phenyl oxide and tris (2-chloro ethyl) phosphate.

The untreated gin trash employed in the fabrication of the moldable composite building materials is, as previously stated, by-products from the cleaning of cotton. Consequently, such untreated gin trash often contains up to about 20 weight percent fines, as previously defined. It has been found that in the fabrication of the moldable composite building materials of the present invention the presence of such fines does not adversely affect the structural or moldable characteristics of the moldable building materials.

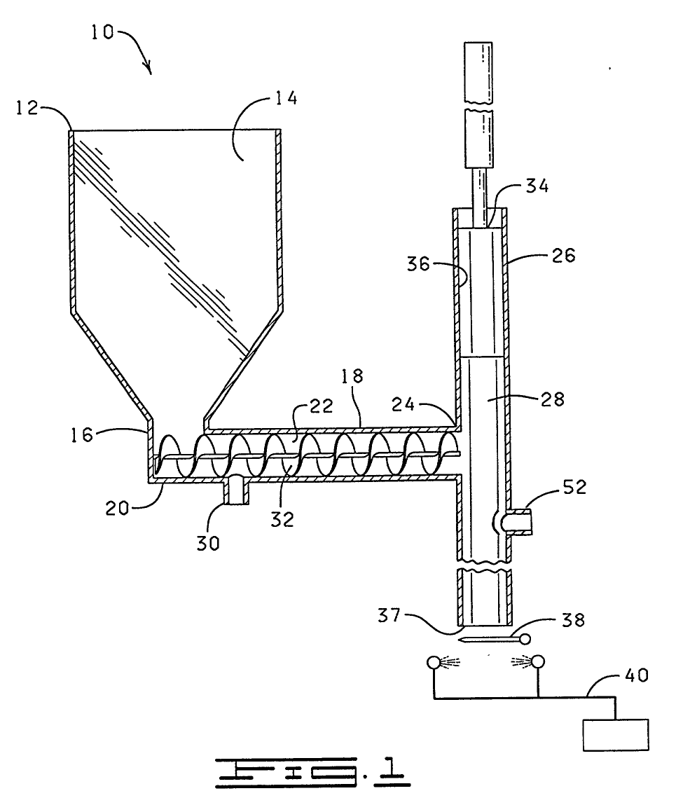

Referring now to the drawings, and more particularly to FIG. 1, an apparatus 10 for manufacturing the moldable composite building materials of the present invention is illustrated. The apparatus 10 includes a hopper 12 having a cavity 14 and a discharge spout 16. An auger tube 18 is connected at first end 20 thereof to the discharge spout 16 of the hopper 12 so that fluid communication is provided between the cavity 14 of the hopper 12 and a bore 22 of the auger tube 18. In an alternate embodiment, not shown, the auger tube 18 may be replaced by a conventional conveyor belt apparatus. One of ordinary skill in the art would appreciate that the auger/conveyor belt interchangeability would be necessitated by the consistency and quality of gin trash being used. For example, the conveyor belt may be used if the gin trash has a high content of cotton lint which would clog up the auger tube 18.

A second end 24 of the auger tube 18 is connected to an extrusion tube 26 so as to provide fluidic communication between the bore 22 of the auger tube 18 and a bore 28 of the extrusion tube 26.

The auger tube 18 is provided with an injection port 30 disposed near the first end 20 of the auger tube 18, substantially as shown. An auger blade 32 is rotatably mounted within the auger tube 18 and extends from the first end 20 of the auger tube 18 to the second end 24 thereof. The injection port 30 provides fluidic communication with the bore 22 of the auger tube 18 so that liquid constituents, such as the binder and/or fire retardant agents, employed in the fabrication of the moldable composite building materials can be introduced into the auger tube 18 for admixture with the untreated gin trash in the auger tube 18 by actuation of the auger blade 32. The resulting admixture is then discharged into the bore 28 of the extrusion tube 26.

A ram 34 is slidably disposed within the bore 28 of the extrusion tube 26 so as to be selectively movable between a retracted position wherein the ram 34 is disposed in an upper end 36 of the bore 28 of the extrusion tube 26 (substantially as shown in FIG. 1) and an extended position wherein the ram 34 applies a force of from about 300 psi to about 3,000 psi to the admixture of the binder and untreated gin trash is discharged into the bore 28 of the extrusion tube 26. It will be appreciated that the admixture of the untreated gin trash and binder will be metered into the bore 28 of the extrusion tube 26 in predetermined amounts. The admixture of the untreated gin trash and the binder is sufficiently viscous that the bore 28 of the extrusion tube 26 supplies sufficient resistance to allow the admixture to be compressed to a satisfactory density by the ram 34.

The extrusion tube 26 is provided with an injection port 52 downstream from the auger tube 18, substantially as shown. The injection port 52 provides fluidic communication with the bore 28 of the extrusion tube 26 so that gaseous constituents, such as carbon dioxide or a fluid capable of producing carbon dioxide, employed in the fabrication of the moldable composite building materials can be introduced into the extrusion tube 26 for lowering the pH of the binder and thereby crystallizing the binder of the moldable composite building materials in the extrusion tube 26. For example, when injecting a sufficient amount of carbon dioxide to substantially saturate the binder with carbon dioxide, the addition of carbon dioxide lowers the pH of the binder from about 5.25 to about 3.0 and thereby crystallizes the binder so that a hardened composite material is provided. Once the admixture has been compressed and the binder crystallized, continued actuation of the ram 34 causes the compressed admixture of the untreated gin trash and binder to be extruded from a lower end 37 of the extrusion tube 26.

The apparatus 10 also includes a cutter 38 located a predetermined distance from the lower end 37 of the extrusion tube 26 for selectively cutting the extruded compressed material into composite materials having a predetermined length. A coating attachment 40 is positioned downstream of the cutter 38 so that the desired amount of sealer can be applied to the composite material.

In operation of the apparatus 10, from about 84 to about 90 weight percent will be made up of the gin trash (based on the weight of the composite construction material) is introduced into the cavity 14 of the hopper 12. The untreated gin trash will not be washed, beaten or chopped, but it may be warmed to room temperature by air to improve the binding of the untreated gin trash with the binder. The untreated gin trash will be introduced into the hopper 12 in the state in which it is collected, without further processing.

The untreated gin trash is pushed downward in the cavity 14 of the hopper 12 by gravity and by the action of the auger blade 32 toward the discharge spout 16 and into the bore 22 of the auger tube 18. The untreated gin trash is pulled through the bore 22 of the auger tube 18 and toward the bore 28 of the extrusion tube 26 by the action of the auger blade 32. At the same time, the untreated is mixed with about 3 to about 10 weight percent binder introduced into the bore 22 of the auger tube 18 by way of the injection port 30, creating a viscous material. If a fire retardant agent is used, the fire retardant agent is normally admixed and added with the sealer. In a typical example, about one and one half (1½) ounces of binder is used per pound of cellulose mixture.

A metered amount of the viscous material is introduced into the bore 28 of the extrusion tube 26, where the viscous material is subjected to from 300 to about 3000 p.s.i. of pressure from the ram 34, creating a compacted composite material having a density of from about 15 to about 40 pounds per cubic foot. A typical example will have a density of about 25 pounds per cubic foot. At the same time, the untreated gin trash is exposed to carbon dioxide gas introduced into the bore 28 of the extrusion tube 26 by way of the injection port 52, creating a crystallized composite material.

A compacted composite material is extruded from the lower end 37 of the extrusion tube 26, where the compacted composite material is cut to a pre-determined length by the cutter 38. The cut compacted composite material is then coated with from about 3 to about 10 weight percent sealer by the coating attachment 40, creating thereby the composite construction material. In a typical example about one and one half (1½) ounces of sealer is used per pound of compacted composite material.

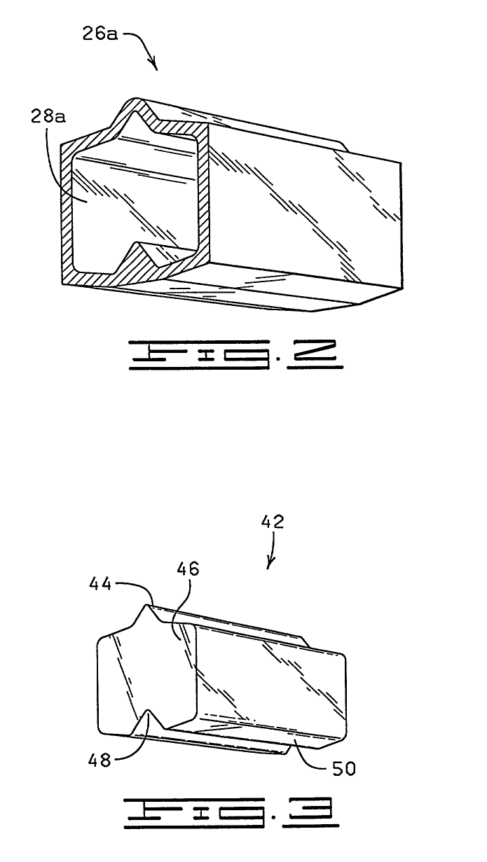

Shown in FIG. 2 is a section of an extrusion tube 26a having a bore 28a. The viscous material, when forced through the bore 28a of the extrusion tube 26a by the ram (shown in FIG. 1), generally conforms to the shape of the bore 28a of the extrusion tube 26a.

FIG. 3 shows a block 42 of moldable composite building material extruded from the extrusion tube 26a in FIG. 2. The block 42 is shaped to have a tongue 44 on a first surface 46 and a groove 48 on a second surface 50. However, it will be appreciated that a block 42 of virtually any shape can be formed in the extrusion process; alternately, the moldable composite building material can be formed in molds, as is well known.

Thus, it should be apparent that there has been provided in accordance with the present invention a moldable composite building material that fully satisfies the objectives and advantages set forth above. Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

What is claimed is:

1. A moldable composite building material comprising an admixture of untreated gin trash and an effective amount of binder capable of binding the untreated gin trash into a composite material.

2. The moldable composite building material of claim 1, further comprising an effective amount of sealer capable of providing a substantially fluid impervious building material.

3. The moldable composite building material of claim 2, wherein the untreated gin trash is from about 80 to about 94 weight percent, the effective amount of binder present is from about 3 to about 5 weight percent, and the effective amount of sealer employed is from about 3 to about 10 weight percent.

4. The moldable composite building material of claim 3, wherein the moldable composite building material has a density of from about 15 to about 40 pounds per cubic foot.

5. The moldable composite building material of claim 1 wherein the untreated gin trash is cotton gin waste products.

6. The moldable composite building material of claim 1, wherein the binder is sodium silicate.

7. The moldable composite building material of claim 6, wherein the binder is from about 3.6 weight percent of the moldable composite building material.

8. The moldable composite building material of claim 7, wherein the moldable composite building material has a density of from about 25 pounds per cubic foot.

9. The moldable composite building material of claim 1, wherein the sealer is latex paint.

10. The moldable composite building material of claim 1, wherein the untreated gin trash further comprises from about 1 to about 5 weight percent foreign material.

11. The moldable composite building material of claim 10, wherein the foreign material is fines.

12. The moldable composite building material of claim 1, further comprising from about 1 to about 5 percent fireproofing agent.

13. A method for making a moldable composite building material, comprising the steps of:
admixing from about 85 to about 94 weight percent gin trash and from about 3 to about 10 weight percent binder, creating a viscous mixture;
compacting the viscous mixture with a pressure of from about 300 p.s.i. to about 3000 p.s.i.;
injecting into the compacted viscous material an effective amount of carbon dioxide to crystallize the binder and produce a compacted composite material; and
coating the compacted composite mixture with from about 3 to about 5 weight percent sealer, thereby producing the moldable composite building material.

14. The method of claim 13, wherein in the step of admixing the gin trash, the gin trash is cotton gin waste.

15. The method of claim 13, wherein in the step of admixing the gin trash, the binder is sodium silicate.

16. The method of claim 13, wherein in the step of coating the compacted composite mixture, the sealer is latex paint.

17. The method of claim 13, further comprising the step of adding a fireproofing agent to the viscous mixture.

18. The method of claim 13, wherein in the step of compacting the viscous mixture, the viscous mixture is molded into a predetermined shape.

19. The method of claim 13, wherein in the step of producing a moldable composite building material, the moldable composite building material has a density of from about 15 to about 40 pounds per cubic foot.
